(19) United States
(12) Patent Application Publication
(10) Pub. No.: US 2025/0055023 A1
(43) Pub. Date: Feb. 13, 2025

(54) METHOD FOR RENEWING OR RECOVERING PERFORMANCE OF HALIDE-BASED SOLID ELECTROLYTE

(71) Applicants: LG ENERGY SOLUTION, LTD., Seoul (KR); THE REGENTS OF THE UNIVERSITY OF CALIFORNIA, Oakland, CA (US)

(72) Inventors: Jung Pil LEE, Daejeon (KR); Jeongbeom LEE, Daejeon (KR); Min Sang SONG, Daejeon (KR); Ying Shirley MENG, San Diego, CA (US); Zheng CHEN, San Diego, CA (US); Yu-Ting CHEN, La Jolla, CA (US)

(73) Assignees: LG ENERGY SOLUTION, LTD., Seoul (KR); THE REGENTS OF THE UNIVERSITY OF CALIFORNIA, Oakland, CA (US)

(21) Appl. No.: 18/461,166

(22) Filed: Sep. 5, 2023

Related U.S. Application Data
(60) Provisional application No. 63/518,260, filed on Aug. 8, 2023.

(51) Int. Cl. H01M 10/0562

(52) U.S. Cl. CPC H01M 10/0562; H01M 2300/008

(57) ABSTRACT

Methods for recovering the performance of a halide-based solid electrolyte are described. In one aspect, a halide-based solid electrolyte that has been exposed to air is subjected to a heat-treatment process, where the performance of the halide-based solid electrolyte is recovered, e.g., the ionic conductivity obtained after heat treatment is recovered to a level similar to that before air exposure.

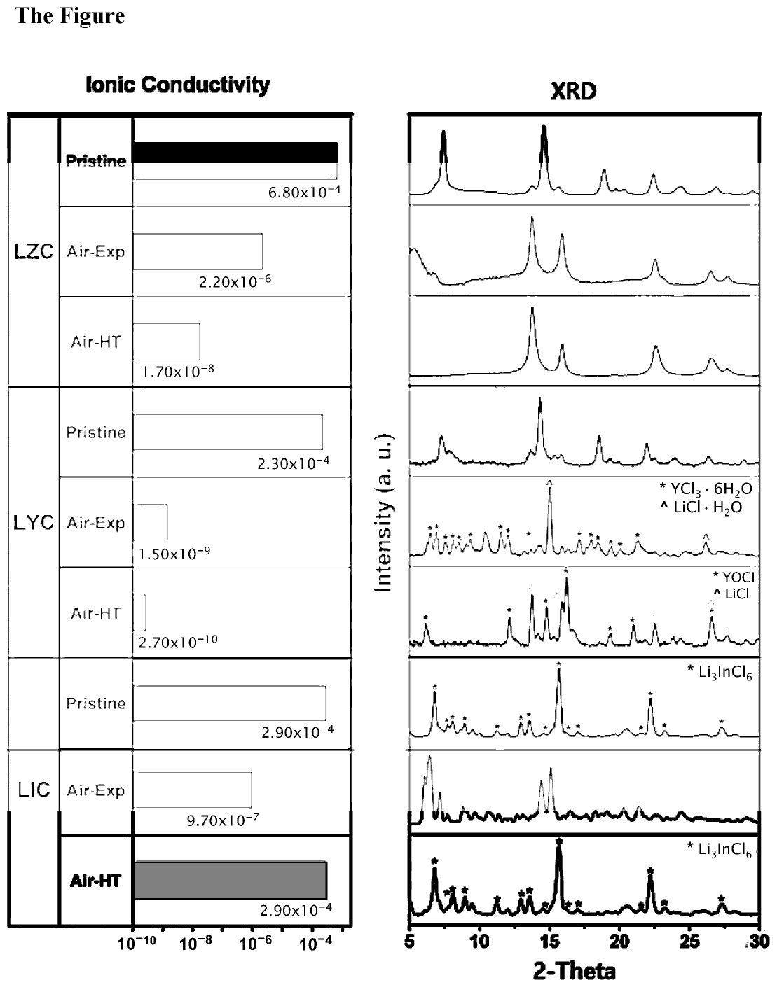

### CROSS-REFERENCE TO RELATED APPLICATION

This non-provisional application claims the benefit under 35 U.S.C. § 119 (e) to U.S. Provisional Application No. 63/518,260, filed on Aug. 8, 2023, all of which is hereby expressly incorporated by reference into the present application.

### TECHNICAL FIELD

The present disclosure relates to methods for renewing or recovering the performance of a halide-based solid electrolyte, as well as an all-solid-state battery comprising the halide-based solid electrolyte.

### BACKGROUND

Lithium batteries have certain limitations in terms of capacity, safety, output, large size, and miniaturization of batteries. Thus, there continues to be a need for alternative battery technology, which address these shortcomings.

Some alternatives to lithium secondary batteries being researched include: a metal-air battery with a very large theoretical capacity in terms of capacity; an all-solid-state battery with no risk of explosion in terms of safety; a supercapacitor in terms of output; a NaS battery or a redox flow battery (RFB) in terms of large size; a thin film battery in terms of miniaturization.

In an all-solid-state battery, a liquid electrolyte (as used in conventional lithium secondary batteries) is replaced by a solid electrolyte. Thus, it is possible to avoid using a flammable solvent in the battery, and safety can be improved, e.g., by avoiding the risk of ignition or explosion due to the decomposition or reaction of the conventional electrolytic solution. In addition, since the all-solid-state battery may use Li metal or Li alloy as a negative electrode material, an all-solid-state battery has the advantage of dramatically improving energy density relative to a mass and volume of a battery.

However, because the all-solid-state battery uses a solid electrolyte, ionic conductivity may be reduced. In addition, when a liquid electrolyte is used together as a means to secure the ionic conductivity of the solid electrolyte, there is a problem in that the intensity is lowered.

In general, in order to prevent degradation of performance and processability of batteries while securing the safety of the all-solid-state battery, both the ionic conductivity and strength of the solid electrolyte should be maintained at a certain level.

However, there remains a need in the art for solid electrolytes that have both sufficient ionic conductivity and strength.

Among solid electrolytes, halide-based solid electrolytes have high oxidation stability, and thus, the demand for the halide-based solid electrolytes is increasing. However, the halide-based solid electrolytes are vulnerable to moisture compared to conventional sulfide-based solid electrolytes, and thus there is a problem in that the performance and processability of the batteries deteriorate.

Therefore, there is a need in the art to develop a technology for improving water resistance of a halide-based solid electrolyte, and/or recovering performance of the halide-based solid electrolyte exposed to moisture.

### RELATED ART DOCUMENT

### Patent Document

(Patent Document 1) Japanese Laid-open Patent Publication No. 2013-219017

### Technical Problem

As a result of various studies to solve the above problems, the present inventors have found that when a halide-based solid electrolyte (e.g., Li₃InCl₅(LIC), etc.) is exposed to moisture-containing air and then heat-treated at a certain temperature, the heat treatment functions to restore the ionic conductivity that was lost due to the exposure to moisture. In an aspect, the ionic conductivity is recovered up to the level of ionic conductivity before the exposure to moisture.

Accordingly, an aspect of the present disclosure provides a method for recovering or renewing the performance of a halide-based solid electrolyte.

### Technical Solution

To achieve the above object, one aspect of the present disclosure provides a method for recovering the performance of a halide-based solid electrolyte including the steps of: (S1) providing a halide-based solid electrolyte that has been exposure to air; and (S2) heat-treating the halide-based solid electrolyte that has been exposed to the air.

In an embodiment of the present invention, the heat treatment may be performed at a temperature of 200° C. to 400° C. In an aspect, the heat treatment may be performed at a temperature of 220° C. to 380° C., a temperature of 250° C. to 350° C., a temperature of 275° C. to 325° C., or a temperature of 300° C. to 350° C.

In an embodiment of the present invention, the heat treatment may be performed in ambient air. In an aspect, the heat treatment may be performed under an inert atmosphere.

In an embodiment of the present invention, the halide-based solid electrolyte may be a lithium halide-based solid electrolyte.

In an embodiment of the present invention, the lithium halide-based solid electrolyte may include at least one selected from the group consisting of Li₃InCl₆, Li₂ZrCl₆, and Li₃YCl₆.

In an embodiment of the present invention, in the method for recovering the performance of a halide-based solid electrolyte, the recovered performance includes ionic conductivity.

In an embodiment of the present invention, after the heat treatment, the ionic conductivity of the halide-based solid electrolyte may be recovered to 90% to 100% compared to the ionic conductivity before being exposed to the air (e.g., compared to the ionic conductivity of the pristine halide-based solid electrolyte).

### Advantageous Effects

According to one aspect of the present disclosure, it is possible to recover the performance of a halide-based solid electrolyte by a heat treatment method. For instance, by heat-treating a halide-based solid electrolyte that has been exposed to moisture-containing air, the method makes it possible to recover the performance (e.g., to recover the ionic conductivity, etc.) of the halide-based solid electrolyte to a level equivalent to or higher than before the halide-based solid electrolyte was exposed to air and/or moisture. As shown in the FIGURE, the material (i.e., the halide-based solid electrolyte) is recovered.

### BRIEF DESCRIPTION OF DRAWINGS

The FIGURE is a graph illustrating ionic conductivity measurement results and X-ray diffraction (XRD) analysis results for halide-based solid electrolytes exposed to air and then heat-treated in Examples 1, 6, and 7.

### DETAILED DESCRIPTION

Hereinafter, the present invention will be described in more detail to help the understanding of the present invention.

The term “halide-based solid electrolyte” includes an inorganic solid electrolyte that comprises a halide (e.g., fluoride, chloride, bromide, and iodide). In an aspect, the solid electrolyte does not comprise an oxide-based solid electrolyte or a sulfur-based solid electrolyte. In an embodiment of the present invention, the sulfide-based solid electrolyte may include one or more selected from the group consisting of LiPSX (X═Cl, Br or I), LiGePS, and LiPS. For example, the halide-based solid electrolyte may include one or more selected from the group consisting of Li₃YBr₆, Li₃YCl₆ and Li₃YBr₂Cl₄.

In some embodiments, the sulfide-based solid electrolyte particles comprise Li₆PS₅Cl.

However, the sulfide-based solid electrolyte is not limited thereto, and sulfide-based solid electrolytes commonly used in the art may be widely used.

For instance, in some embodiments, the sulfide-based solid electrolyte particles comprise a composite as shown Formula 1 or mixtures thereof:

LiₐM_{b}A_{c}X_{d} [Formula 1]
wherein:
M is selected from P, Sn, Sb, As and Ge;
A is selected from PS, Se and Te;
X is selected from Cl, Br and I; and
wherein 5≤a≤7.5, 0.5≤b≤1.5, 4≤c≤6 and 0.5≤d≤2.

In some embodiments, the halide-based solid electrolyte may be represented by Formula 2 below:

Li₆₋₃ₐMₐBr_{b}Cl_{c} <Formula 2>

wherein, M is a metal other than Li, a is 0<a<2, b is 0≤b≤6, cis 0≤c≤6, and b+c=6. In some aspects, M is a metal other than Li. Preferably, M is selected from Sc, Y, B, Al, Ga and In, wherein 0<a<2, 0≤b≤6, 0≤c≤6 and b+c=6.

As used in the specification, the term “air” refers to a moisture-containing environment, and is not limited by the amount of moisture, temperature or pressure, etc. The term “pristine” may be understood as describing the condition of a halide-based solid electrolyte prior to exposure to air.

### Method for Recovering Performance of Halide-Based Solid Electrolyte

One aspect of the present disclosure relates to a method for recovering performance of a halide-based solid electrolyte. In an aspect, the performance includes ionic conductivity of the halide-based solid electrolyte.

According to one aspect of the present disclosure, a method for recovering performance of halide-based solid electrolyte includes: (S1) exposing a halide-based solid electrolyte to air, or providing a halide-based solid electrolyte after exposure to air, e.g., where the performance of the halide-based solid electrolyte has decreased after air exposure; and (S2) heat-treating the halide-based solid electrolyte that had been exposed to the air. After the heat treatment, performance of the halide-based solid electrolyte is improved. For instance, in an aspect, the performance includes the ionic conductivity of the halide-based solid electrolyte.

In general, halide-based solid electrolytes are vulnerable to moisture, so, when exposed to moisture-containing air, the performance (including ionic conductivity) may deteriorate, e.g., due to a change in internal structure such as hydration, or oxidation of halide elements. When the halide-based solid electrolyte exposed to the air is heat treated, the halide-based solid electrolyte before being exposed to the air is formed again, and the performance including the ionic conductivity may be recovered. In an aspect, as shown in Table 1 below, the halide-based solid electrolyte which forms a hydrate without any oxide is easier to be recovered.

As shown in Table 1, in the case of LIC (Li₃InCl₆), H₂O hydrate of LIC is formed when exposed to moisture or air, but the hydrate is removed during heat treatment and returns to original LIC. Thus, the ionic conductivity is recovered. However, in the case of LZC (Li₂ZrCl₆) or LYC (Li₃InCl₆), which does not form a simple hydrate of LZC or LYC, other by-products are formed and does not change to the original material even after heat treatment.

TABLE 1

| Electrolyte | Exposure | Heat Treatment |
|---|---|---|
| Pristine | Air Exposure | Heat Treatment in Air |
| Li₂ZrCl₆ | LiCl + ZrO₂ + HCl | LiCl + ZrO₂ (350° C.) |
| Li₃YCl₆ | LiCl•H₂O + YCl₃•H₂O | LiCl + YOCl +2 HCl (550° C.) |
| Li₃InCl₆ | Li₃InCl₆•H₂O + a little HCl and In₂O₃ | Li₃InCl₆ + a little In₂O₃ (260° C.) |

In an embodiment of the present invention, the heat treatment may be performed at a temperature of 200° C. to 400° C.

Specifically, the heat treatment temperature may be 200° C. or higher, 220° C. or higher, or 240° C. or higher, and may be 300° C. or lower, 350° C. or lower, or 400° C. or lower. In certain aspects, the lower range may be 200° C. or higher, 210° C. or higher, 220° C. or higher, 230° C. or higher, 240° C. or higher, 250° C. or higher, 260° C. or higher, 270° C. or higher, 280° C. or higher, 290° C. or higher, 300° C. or higher, 310° C. or higher, 320° C. or higher, 330° C. or higher, 340° C. or higher, or 350° C. or higher. In certain aspects, the upper range may be 400° C. or lower, 390° C. or lower, 380° C. or lower, 370° C. or lower, 360° C. or lower, 350° C. or lower, 340° C. or lower, or 325° C. or lower.

In some aspects, when the heat treatment temperature is less than 200° C., components hydrated or oxidized by being exposed to air may not be formed as an original halide-based solid electrolyte, and ionic conductivity may not be recovered. When the heat treatment temperature exceeds 400° C., the process cost for recovering the ionic conductivity in air becomes expensive, and the halide-based solid electrolyte component transformed by exposure induces other side reactions, or the solid electrolyte itself is thermally decomposed, so the ionic conductivity may not be recovered either.

In an embodiment of the present invention, the heat treatment may be performed in the air. The air is not particularly limited as long as it is a moisture-containing environment.

In an embodiment of the present invention, the halide-based solid electrolyte may be a lithium halide-based solid electrolyte. In an aspect, the halide comprises a fluoride, chloride, bromide or iodide.

In an aspect, the method for recovering performance of a halide-based solid electrolyte by the heat treatment relate to a lithium halide-based solid electrolyte, among the halide-based solid electrolytes. The lithium halide-based solid electrolyte is exposed to air, and thus, chemical reaction products on the surface may have a greater tendency to originally form the lithium halide-based solid electrolyte by the heat treatment, which may be more advantageous for recovery of performance including ionic conductivity.

In an embodiment of the present invention, the lithium halide-based solid electrolyte includes at least one selected from the group consisting of Li₃InCl₆, Li₂ZrCl₆, and Li₃YCl₆.

In an embodiment of the present invention, the performance may be the ionic conductivity.

The method for recovering performance of a halide-based solid electrolyte according to an embodiment of the present invention is based on the principle of returning the change in structure of the halide-based solid electrolyte by exposure to air to a state similar to the original structure by the heat treatment, which may be advantageous for the recovery of the ionic conductivity which is highly related to the structure of the halide-based solid electrolyte.

In addition, as can be seen from the XRD results illustrated in the FIGURE, it can be seen that it has returned to the original material.

In an embodiment of the present invention, after the heat treatment, the ionic conductivity of the halide-based solid electrolyte may be recovered to a level of 90% to 100% compared to before being exposed to air, and specifically, recovered to a level of 90% or more, 93% or more, 95% or more, or 98% or more. The degree of recovery of the ionic conductivity may be proportional to the degree of recovery of the internal structure of the halide-based solid electrolyte.

### EXAMPLES

The following examples are exemplary and not intended to be limiting. The above disclosure provides many different embodiments for implementing the features of the invention, and the following examples describe certain embodiments. It will be appreciated that other modifications and methods known to one of ordinary skill in the art can also be applied to the following experimental procedures, without departing from the scope of the invention.

Hereinafter, preferred Example will be provided in order to assist in the understanding of the present invention. However, it will be obvious to those skilled in the art that the following Example is only an example of the present invention and various modifications and alterations may be made without departing from the scope and spirit of the present invention. In addition, it is natural that these modifications and alterations will fall within the following claims.

In the following Examples and Comparative Examples, a halide-based solid electrolyte, an air exposure process, and a heat treatment process as shown in Table 2 below were performed.

TABLE 2

| | | | | | Ionic | | | |
|---|---|---|---|---|---|---|---|---|
| | | | | | conductivity | | | Ionic |
| | | Atmospheric | | | after | | | conductivity |
| | Halide-based | exposure | | Response | being | Heat treatment | | after heat |
| | solid | Humidity | Time | Time | exposed to | Temperature | Time | treatment |
| | electrolyte | (%) | (min) | (hr) | air (S/cm) | (° C.) | (hr) | (S/cm) |
| Example 1 | LIC (Li₃InCl₆) | 45 | 1 | 24 | 9.7 × 10⁻⁷ | 260 | 8 | 2.9 × 10⁻⁴ |
| Example 2 | LIC (Li₃InCl₆) | 45 | 1 | 24 | 9.7 × 10⁻⁷ | 150 | 8 | 1.8 × 10⁻⁶ |
| Example 3 | LIC (Li₃InCl₆) | 45 | 1 | 24 | 9.7 × 10⁻⁷ | 450 | 8 | 2.7 × 10⁻⁴ |
| Example 4 | LIC (Li₃InCl₆) | 45 | 1 | 12 | 1.5 × 10⁻⁶ | 260 | 8 | 2.9 × 10⁻⁴ |
| Example 5 | LIC (Li₃InCl₆) | 45 | 1 | 6 | 1.8 × 10⁻⁶ | 260 | 8 | 2.9 × 10⁻⁴ |
| Example 6 | LZC (Li₂ZrCl₆) | 45 | 1 | 24 | 2.2 × 10⁻⁶ | 350 | 8 | 1.7 × 10⁻⁸ |
| Example 7 | LYC (Li₃Ycl₆) | 45 | 1 | 24 | 1.5 × 10⁻⁹ | 550 | 8 | 2.7 × 10⁻¹⁰ |
| Comparative | LiPSCl(Li₆PS₅Cl) | 45 | 1 | 24 | 9.5 × 10⁻⁷ | 260 | 8 | 2.6 × 10⁻⁴ |
| Example 1 | | | | | | | | |

### Example 1

A halide-based solid electrolyte, Li₃InCl₆ was exposed to air with a humidity of 45% for 1 minute and reacted for 24 hours.

Li₃InCl₆ exposed to and reacted with the air was heat-treated at 260° C. for 8 hours.

### Example 2

Example 2 was performed in the same manner as Example 1, except that the heat treatment temperature is 150° C.

### Example 3

Example 3 was performed in the same manner as Example 1, except that the heat treatment temperature is 450° C.

### Example 4

Example 4 was performed in the same manner as in Example 1, except that a reaction time after being exposed to air was set to 12 hours.

### Example 5

Example 5 was performed in the same manner as in Example 1, except that a reaction time after being exposed to air was set to 6 hours.

### Example 6

Example 6 was performed in the same manner as in Example 1, except that Li₂ZrCl₆ was used as a halide-based solid electrolyte and the heat treatment temperature was set to 350° C.

### Example 7

Example 7 was performed in the same manner as in Example 1, except that Li₃Ycl₆ was used as a halide-based solid electrolyte and the heat treatment temperature was set to 550° C.

### Comparative Example 1

Comparative Example 1 was performed in the same manner as in Example 1, except that Li₆PS₅Cl was used as a sulfide-based solid electrolyte instead of the halide-based solid electrolyte. In aspects according to the invention, the term “halide-based” means comprising Sc, Y, B, Al, Ga and/or In as halide. For instance, Formula 1 is an example of a halide-based solid electrolyte.

### Experimental Example 1: Measurement of Degree of Recovery of Solid Electrolyte Membrane

In order to confirm the degree of recover of performance of a halide-based solid electrolyte exposed to air, the ionic conductivity was measured for the halide-based solid electrolyte before being exposed to air (Pristine), after air exposure (Air-Exp), and after heat treatment (Air-HT). X-ray diffraction (XRD) analysis was performed to analyze internal components of the halide-based solid electrolyte in each step. The ionic conductivity and the XRD analysis method are as follows.

### Measurement of Ionic Conductivity

To measure the ionic conductivity of the solid electrolyte membrane, the solid electrolyte membrane was put in a polyether ether ketone (PEEK) holder with a diameter of 10 mm, and a titanium rod was used as a blocking electrode to measure the ionic conductivity.

After the resistance was measured at 25° C. under conditions of an amplitude of 10 mV and a scan range of 1 Hz to 0.1 MHz by using an electrochemical impedance spectrometer (EIS, VM3, Bio Logic Science Instrument), the ionic conductivity of the solid electrolyte membrane was calculated by using the following Equation 1:

$${σ}_{i} = \frac{L}{RA}$$

In the above Equation 1, σi denotes the ionic conductivity (mS/cm) of the solid electrolyte membrane, R denotes the resistance (Ω) of the solid electrolyte membrane measured by the electrochemical impedance spectrometer, L denotes the thickness (μm) of the solid electrolyte membrane, and A denotes the area (cm²) of the solid electrolyte membrane.

### XRD Analysis

XRD analysis was performed by measuring 2-Theta every 0.01° from 5° to 40° under conditions of Mo Ka radiation (wavelength: 0.70926 Å) by using a Bruker APEX II XRD (voltage: 40 Kv, current: 40 mA). Measurement samples were sampled in a state sealed with boron-rich glass in an Ar-filled glove box to prevent exposure to air.

Table 1 shows the changes in components of halide-based solid electrolytes, which are exposed to air and then heat-treated in Examples 1, 6 and 7, in Chemical Formula.

Referring to Table 1, in Example 1 (LIC, Li₃InCl₆), it could be seen that In₂O₃ was formed by oxidizing In while the LIC was hydrated in the step after exposed to the air (Air-Exp), but in the step after the heat treatment (Air-HT), the hydrated LIC became the original LIC.

In addition, in Example 6 (LZC, Li₂ZrCl₆), it could be seen that Zr was oxidized in the step after exposed to the air (Air-Exp) to form ZrO₂ and HCl, and in the step after the heat treatment (Air-HT), only HCl was removed, but the original LZC was not formed. As a result, it is difficult to recover the ionic conductivity.

In addition, in Example 7 (LZC, Li₂ZrCl₆), it could be seen that LYC was hydrated in the step after exposed to the air (Air-Exp), and in the step after the heat treatment (Air-HT), Y was oxidized and only HCl is formed, but the original LZC was not formed.

The FIGURE is a graph illustrating ionic conductivity measurement results and XRD analysis results for halide-based solid electrolytes exposed to air and then heat-treated in Examples 1, 6, and 7. The ionic conductivity and XRD analysis were conducted in the step before being exposed to air (Pristine), the step after being exposed to air (Air-Exp), and the step after heat treatment (Air-HT), respectively.

Referring to The FIGURE, in Example 1 (LIC), it was confirmed that the ionic conductivity of the step after heat treatment (Air-HT) is the same as the ionic conductivity of the step before being exposed to air (Pristine), and the degree of recovery of the ionic conductivity is 100%. In addition, it could be seen that the XRD analysis result of the step after heat treatment (Air-HT) was also almost the same as the ionic conductivity of the step before being exposed to air (Pristine), so the internal structure of the LIC was recovered to its original material by the heat treatment.

On the other hand, in Example 6 (LZC) and Example 7 (LYC), it could be seen that, when being exposed to moisture, not only simple hydrates such as the LIC, but also the LiCl and other by-products are formed, and these reactions are irreversible reactions and difficult to recover.

Hereinabove, although the present invention has been described by way of limited embodiments and drawings, the present invention is not limited thereto, but may be variously modified and altered by those skilled in the art to which the present invention pertains within the equivalent scope of the technical spirit the present invention and the claims to be described below. Having now fully described this invention, it will be understood by those of ordinary skill in the art that it can be performed within a wide equivalent range of parameters without affecting the scope of the invention or any embodiment thereof.

All publications, patent applications and patents disclosed herein are incorporated by reference in their entirety.

Unless specified otherwise, all the percentages, portions and ratios in the present invention are on weight basis. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Moreover, the indefinite articles “a” or “an,” as used in the claims, are defined herein to mean one or more than one of the element that it introduces. While compositions and methods are described herein in terms of “comprising” various components or steps, the compositions and methods can also “consist essentially of” or “consist of” the various components and steps.

What is claimed is:

1. A method for renewing a halide-based solid electrolyte, comprising:
(S1) providing a halide-based solid electrolyte that has been exposed to air, wherein the performance of the halide-based solid electrolyte is decreased compared to a corresponding pristine state prior to being exposed to air; and
(S2) heat-treating the halide-based solid electrolyte from (S1) to provide a renewed halide-based solid electrolyte.

2. The method of claim 1, wherein the heat treatment in (S2) is performed at a temperature of about 200° C. to 400° C.

3. The method of claim 1, wherein the heat treatment in (S2) is performed at a temperature of about 250° C. to about 350° C.

4. The method of claim 1, wherein the heat treatment in (S2) is performed in air.

5. The method of claim 1, wherein the heat treatment in (S2) is performed under ambient conditions.

6. The method of claim 1, wherein the heat treatment in (S2) is performed at a pressure of about 1 atm.

7. The method of claim 1, wherein the heat treatment in (S2) is performed for a time up to 12 hours.

8. The method of claim 1, wherein the heat treatment in (S2) is performed for a time from about 30 minutes to 8 hours.

9. The method of claim 1, wherein the heat treatment in (S2) is performed for a time from about 1 hour to 3 hours.

10. The method of claim 1, wherein the heat treatment in (S2) is performed in an oven.

11. The method of claim 1, wherein the halide-based solid electrolyte comprises fluorine, chlorine, bromine or iodine.

12. The method of claim 1, wherein the halide-based solid electrolyte is a lithium halide-based solid electrolyte.

13. The method of claim 4, wherein the lithium halide-based solid electrolyte includes at least one selected from the group consisting of Li₃InCl₆, Li₂ZrCl₆, and Li₃YCl₆.

14. The method of claim 1, wherein the ionic conductivity of the renewed halide-based solid electrolyte after heat-treating in (S2) is about 80% to 100% of a corresponding pristine halide-based solid electrolyte.

15. The method of claim 1, wherein, after the heat treatment, the ionic conductivity of the halide-based solid electrolyte is recovered to 90% to 100% compared to before being exposed to the air.
